(19) United States
(12) Patent Application Publication
(10) Pub. No.: US 2020/0141734 A1
(43) Pub. Date: May 7, 2020

(54) CROWDSOURCED MAPPING OF ENVIRONMENTAL HAZARDS

(71) Applicant: DOMINION ENGINEERING, INC., Reston, VA (US)

(72) Inventors: Christopher Ramiro CASAREZ, Washington, DC (US); Michael James LITTLE, Ashburn, VA (US)

(73) Assignee: Dominion Engineering, Inc., Reston, VA (US)

(21) Appl. No.: 16/495,940

(22) PCT Filed: Mar. 21, 2018
(86) PCT No.: PCT/US2018/023655

§ 371 Date: Sep. 20, 2019

Related U.S. Application Data
(60) Provisional application No. 62/474,424, filed on Mar. 21, 2017.

(51) Int. Cl. G01C 21/20

(52) U.S. Cl. CPC G01C 21/206; G06F 16/29

(57) ABSTRACT

A system and method of generating a real-time, crowdsourced visual map summarizing measurements reflecting environmental conditions affecting personnel safety in an industrial facility or work area is provided. The method includes receiving a request for a measurement map from a user, wherein the request includes an indication of the floor plan of interest of the facility; retrieving an image of the floor plan of interest; receiving measurement data and positional data from one or more portable measurement devices in the industrial facility or work area, wherein the portable measurement devices are either worn by workers, mounted to robotic platforms, carried by workers as hand-held instruments, or mounted to stationary equipment or structures; spatially interpolating the received measurement data with the positional data; overlaying the spatially interpolated measurement data on the floor plan of interest to generate a continuously updated visual map of industrial safety conditions present within the area of interest; and displaying the visual map to the user.

### CROSS-REFERENCE TO PRIOR APPLICATIONS

This application claims priority to U.S. Provisional Patent Application No. 62/474,424, filed on Mar. 21, 2017, which is incorporated by reference herein in its entirety.

### FIELD

The exemplary embodiments relate generally to the field of real-time monitoring of environmental hazards to support industrial safety. More particularly, the exemplary embodiments aggregate combined environmental measurement and position data received from fixed and/or mobile (e.g., instrumented plant personnel or robots) electronic monitoring and positioning devices distributed throughout an industrial setting to generate an accurate, real-time visual map of the environmental conditions throughout the industrial setting. The embodiments will be described in connection with such utility, although other utilities are contemplated.

### BACKGROUND

Industrial environments typically include a number of hazards that have the potential to cause damage to equipment and to create safety risks. Such hazards may include, for example, radiation hazards, chemical hazards, biological hazards, thermal hazards, audio hazards, etc. It is highly desirable that measures be taken to reduce or limit the exposure of persons, equipment, products and the environment to such hazards in the industrial settings. As a result, industrial settings often include precautionary or “safety” systems that monitor various environmental factors in an effort to use this environmental monitoring information to reduce the risks of equipment damage, product losses, and exposure of workers to safety hazards. Such safety systems are typically operated in a “static” manner meaning that environmental conditions are measured at discrete locations and times. Due to inherent spatial and temporal variability in environmental conditions within typical industrial settings, a common shortcoming of such systems is the obsolescence of the collected data before strategies can be implemented to optimize worker, equipment, and product safety in response to the identified hazards and their location throughout the industrial setting.

For example, radiological conditions at nuclear facilities, such as dose rates and contamination levels, are typically taken at discrete locations and times. These measurements are then used to prepare radiological survey maps at discrete times, which are then used to plan worker activities to minimize radiological worker exposures until the next survey is performed. In the interim time between discrete radiological surveys, radiological conditions may change substantially due to changes in equipment operation, water levels within components (which provide shielding from radioactivity), maintenance and inspection activities such as radiography, and other factors. Therefore, as time passes, there is diminishing probability that prior surveys of radiological conditions accurately reflect the current conditions, which increases the risk of worker exposure to unanticipated and potentially more severe radiological conditions.

For improved planning of work activities and greater assurance that exposure of persons, equipment, products and the environment to such hazards will be minimized, it is desirable to maintain more accurate and up-to-date data regarding environmental conditions and to make this information available to industrial personnel and workers in a readily useable form. A need therefore exists for a system and method which provides accurate, real-time visual mapping and summary of environmental conditions and hazards throughout an industrial setting.

### SUMMARY

Aspects of the exemplary embodiments relate to systems and/or methods for environmental condition mapping which utilize data from electronic monitoring and positioning devices worn by each individual plant worker, integrated into robots, and/or located throughout an industrial setting. The combined environmental measurement and position data for each worker or device is monitored and recorded as a function of time as the plant workers/robots move throughout the industrial setting and the environmental conditions change. Geospatial and statistical techniques are then used to aggregate measurements from workers/devices and display this data as an accurate, real-time visual map of environmental conditions throughout the industrial setting.

The implementations of the exemplary embodiments herein provide significant improvement in inputs available for hazard mitigation strategy development. In particular, the systems and/or methods of the exemplary embodiments generate high-fidelity, real-time visual maps of environmental conditions throughout an industrial setting utilizing accurate and up-to-date data regarding one or more environmental factors pertinent to the industrial setting. This information can then be used to reduce exposure of persons, equipment, products and the environment to the hazards in real-time. As used herein, environmental factors include but are not limited to radiation (dose rates, contamination levels, etc.), chemical exposure (concentration of noxious gasses, concentration of explosive gasses, etc.), airborne particulates, biological exposure (e.g., infectious diseases), thermal hazards, noise hazards and the like. In the systems and/or methods of the exemplary embodiments, the monitoring and positioning devices, the data from which are used to generate the aforementioned real-time hazard maps, may be personal monitoring and positioning devices worn by each individual worker and/or may be, integrated within robots and/or may be integrated within fixed environmental monitoring stations. As will be appreciated by those skilled in the art, a sensor or sensing device may optionally be integrated with a location tracking device depending on the environmental hazards that exists in a given industrial setting.

In one exemplary embodiment, a method of generating a real-time, crowdsourced visual map summarizing measurements reflecting environmental conditions affecting personnel safety in an industrial facility or work area is provided. The method includes receiving a request for a measurement map from a user, wherein the request includes an indication of the floor plan of interest of the facility; retrieving an image of the floor plan of interest; receiving measurement data and positional data from one or more portable measurement devices in the industrial facility or work area, wherein the portable measurement devices are either worn by workers, mounted to robotic platforms, carried by workers as hand-held instruments, or mounted to stationary equipment or structures; spatially interpolating the received measurement data with the positional data; overlaying the spatially interpolated measurement data on the floor plan of interest to generate a continuously updated visual map of environmental conditions affecting personnel safety within the area of interest; and displaying the visual map to the user.

In another exemplary embodiment, a system for generating a real-time, crowdsourced visual map summarizing measurements reflecting environmental conditions affecting personnel safety in an industrial facility or work area is provided. The system including one or more portable measurement devices which collect environmental hazard and positional data, wherein the portable measurement devices are either worn by workers, mounted to robotic platforms, carried by workers as hand-held instruments, or mounted to stationary equipment or structures. The system also including a computer system that includes one or more physical processors programmed with computer program instructions that, when executed, cause the computer system to receive a request for a measurement map from a user, wherein the request includes an indication of the floor plan of interest of the facility; retrieving an image of the floor plan of interest; receiving measurement data and positional data from one or more portable measurement devices in the industrial facility or work area, wherein the portable measurement devices are either worn by workers, mounted to robotic platforms, carried by workers as hand-held instruments, or mounted to stationary equipment or structures; spatially interpolate the received measurement data with the positional data; overlay the spatially interpolated measurement data on the floor plan of interest to generate a continuously updated visual map of environmental conditions affecting personnel safety within the area of interest; and display the visual map to the user

Various other aspects, features, and advantages of the exemplary embodiments will be apparent through the detailed description of the exemplary embodiments and the drawings attached hereto. It is also to be understood that both the foregoing general description and the following detailed description are exemplary and not restrictive of the scope of the exemplary embodiments. As used in the specification and in the claims, the singular forms of “a”, “an”, and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIGS. 1 and 2 show an exemplary embodiment of an environmental mapping system which utilizes data from personal/automated monitoring and positioning devices, in accordance with one or more embodiments.

FIGS. 3A-D show an exemplary real-time visual map of environmental conditions present in controlled areas within an industrial setting, in accordance with one or more embodiments.

FIG. 4 shows a flowchart of a method for spatial interpolation, in accordance with one or more embodiments.

FIG. 5 shows a flowchart of a method for generating and displaying a visual map of environmental conditions present in controlled areas within an industrial setting, in accordance with one or more embodiments.

### DETAILED DESCRIPTION OF THE EXEMPLARY EMBODIMENTS

In the following description, for the purposes of explanation, numerous specific details are set forth in order to provide a thorough understanding of the exemplary embodiments. It will be appreciated, however, by those having skill in the art that the exemplary embodiments may be practiced without these specific details or with an equivalent arrangement. In other instances, well-known structures and devices are shown in block diagram form in order to avoid unnecessarily obscuring the exemplary embodiments.

Configuration of Environmental Mapping System

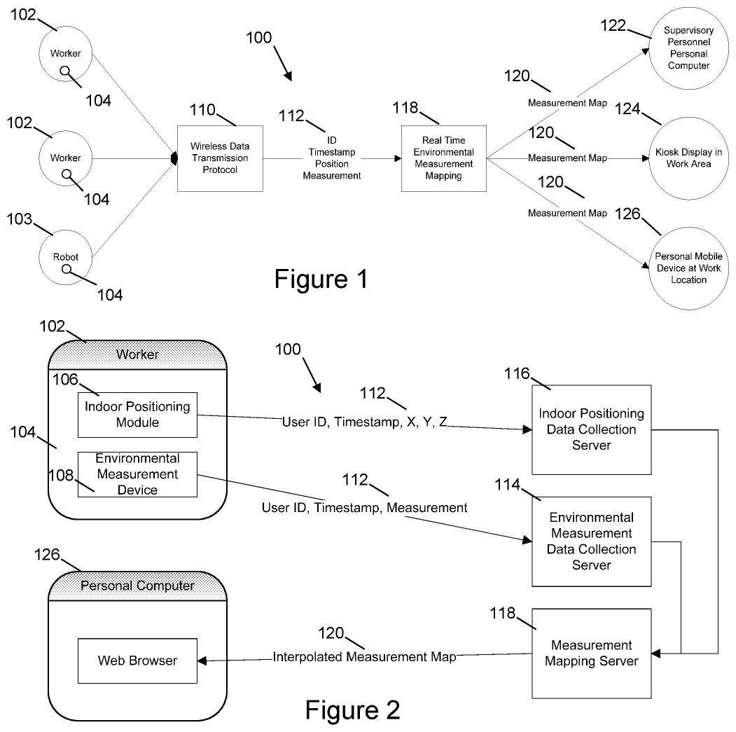

Exemplary embodiments of an environmental mapping system 100 which utilizes data from electronic monitoring and positioning devices 104 positioned throughout an industrial setting are illustrated in FIGS. 1 and 2. Upon entering a controlled area in an industrial setting, each worker 102 or robot 103 may carry/convey a monitoring and positioning device 104 to monitor their exposure to nearby environmental hazards during work and non-work activities. It should be appreciated that during work and non-work activities, numerous workers 102 and/or robots 103 may be moving or working within these controlled areas at any given time. Environmental measurement data may be obtained using monitoring and positioning devices 104 worn by each worker 102 and/or robot 103 and utilized primarily to monitor and document the exposure of the monitored individuals 102/robots 103 to environmental factors and/or hazards. While moving within the controlled area, the monitoring and positioning device 104 for each plant worker 102/robot 103 may obtain data associated with the worker's/robot's hazards exposure during work activities. In some embodiments, the measurement data for each plant worker 102/robot 103 is processed to determine a corresponding exposure level. In some embodiments, the measurement data is post-processed to calculate cumulative exposure of users to one or more environmental hazards during normal operation of the industrial facility. In other embodiments, the measurement data is post-processed to calculate cumulative exposure of users to one or more environmental hazards following an industrial safety event. In some embodiments, individual users are notified via one or more portable measurement devices of their cumulative exposure level approaching or exceeding a pre-determined threshold.

With reference to FIG. 2, each monitoring and positioning device 104 may include an electronic positioning device 106 and an environmental monitoring device 108 that is worn by the plant worker while working in a controlled area. For example, the monitoring and positioning device 104 may be an electronic personal measurement device (handheld or worn) used by individual workers 102. In some embodiments, the electronic personal measurement device may include an integral or attached location tag and a button to log a measurement. In another example, the monitoring and positioning device 104 may be a robot 103 which incorporates a measurement and positioning device 104 to provide better coverage in areas with dangerous exposure levels. It should be appreciated that such a robot may consist of, but would not be limited to, land-based unmanned vehicles and unmanned drones such as UAVs that are able to reach difficult locations and may be autonomous, semi-autonomous, or remotely operated. It should also be appreciated that the monitoring and positioning device 104 may either be two separate devices (an electronic monitoring device and position monitoring device) or a single device (a combined electronic monitoring and position device) that monitors both environmental factors and position. In some embodiments, the monitoring and positioning device 104 is configured to acquire environmental measurements in a continuous, periodic, or automated manner.

In some embodiments, the monitoring and positioning device 104 may monitor different types of environmental factors including but not limited to radiation factors (dose rates, contamination levels, etc.), chemical exposure factors (corrosive liquids, noxious or explosive gasses, etc.), airborne particulates, biological factors (e.g., infectious diseases), temperature, noise, or a combination thereof. Personal positioning may be monitored, for example, using radio frequency time-of-flight triangulation techniques using a plurality of positioning beacons placed near or within the controlled area and a specialized transceiver worn by the plant worker 102 or integrated into the robot 103. The location and number of positioning beacons may be optimized to achieve the desired level of accuracy and precision. Inertial measurements may also be used along with trilateration between transceivers worn by plant workers 102/robots 103 and positioning beacons in order to enhance the precision of position data. In some embodiments, the monitoring and positioning device 104 may utilize the global positioning system (GPS), ultra wideband indoor positioning (UWB), beacon indoor positioning system (BLE), inertial measurement units (IMU), RFID, or other positioning methods to provide the position data for each worker 102/robot 103.

With continuing reference to FIG. 1, the environmental measurement and position data for each plant worker 102/robot 103 may be preferably transmitted to central data storage media located in one or more servers, in real-time using an appropriate wireless data communications system 110 such as, for example, Wi-Fi, 4G, or other protocol that provides continuous or nearly continuous connectivity throughout the facility. Alternatively, asynchronous data transmission may be used in cases where connectivity to a data network is not available throughout the facility. For example, environmental measurement and position data as a function of time may be transmitted to a central data storage medium using a near-field communications protocol such as Bluetooth or RFID when the plant worker 102/robot 103 logs out of the controlled area or when the plant worker 102/robot 103 reaches an area in which connectivity to an appropriate wireless data network is available. Regardless of whether real-time or asynchronous data transmission is used, the monitoring and positioning device(s) 104 may have internal storage to ensure data is retained when data transmission protocols are unavailable.

In some embodiments, the environmental measurement and position data may be standardized 112 to include the worker/robot ID, timestamp, position data, measurement data, and the like. For example, environmental measurement and position data may be associated with a specific plant worker's identity such as the worker's badge number, passive measurement device number or other identifier to facilitate additional real-time or post-processing diagnostics, if desired. In some embodiments, such identity associations may be optionally anonymized for specific individuals, as appropriate, or access to the location and identity of specific individuals within the plant may be limited by software security settings. Alternatively, selected plant workers, such as security personnel, may not wear location monitoring devices of the type described herein for facility security reasons. In some embodiment, the environmental measurement and position data may be provided with a timestamp. For example, the monitoring and positioning device 104 may obtain the environmental measurement and position data as a function of time by which the timestamp is generated.

In some embodiments, the environmental measurement and position data may be transmitted to and stored in a measurement data collection server 114 and a positioning data collection server 116. It should be appreciated that the data collection servers 114, 116 may either be two separate servers (a measurement data collection server 114 and a positioning data collection server 116) or a single data collection server which may store the environmental measurement and position data as a function of time.

Once environmental measurement and position data as a function of time are available on the data collection server, analysis software residing in an environmental condition mapping server 118 may be utilized to analyze and aggregate data from all monitoring and positioning devices 104 using statistical techniques, and display the data as real-time visual maps 120 of current environmental conditions present in controlled areas within the industrial setting. In some embodiments, the visual maps 120 are generated updated in a continuous or periodic manner. In some embodiment, the environmental condition mapping server 118 may create visual maps of historical environmental conditions in controlled areas within the industrial setting. The magnitude of environmental factors, time that has passed since these measurements were obtained, and other factors may be considered in the analysis and display routines to ensure that these visual maps are useful for planning and work activity controls. The analysis software may utilize a regression model, such as a Kriging model, that considers uncertainties associated with individual environmental and position measurements and/or variations due to time to create a visual map of environmental conditions that includes inferred predictions for locations with no measurement data. For example, the analysis software may determine the locations with hazardous exposure levels, based on pre-determined thresholds for the metric being measured (e.g., radiation dose rate, flammable gas concentration, etc.), and plan work activities around these areas until a safer exposure level exists. It should be appreciated that the environmental condition mapping server 118 may be located within the industrial setting, at a central location, or in a cloud remote infrastructure.

In some embodiment, the environmental condition mapping server 118 may identify one or more areas of the industrial setting which have abnormal environmental conditions. For example, the environmental condition mapping server 118 may calculate the difference between values (e.g., radiation dose rates) in the most recent spatially interpolated map of measurement data and those in prior spatially interpolated maps of measurement data. Based on the results of the calculation, an area having abnormal environmental conditions may be identified. In response to an abnormal environmental conditions being identified, the environmental condition mapping server 118 may add an indication of the abnormal environmental conditions as an overlay to the existing visual map displayed to the worker. As stated earlier, a particular area may be determined to have hazardous environmental conditions irrespective of the difference between current and prior measurements based on pre-determined thresholds for the metric being measured (e.g., radiation dose levels, flammable gas concentration, etc.). However, a rapid jump in any metric could suggest the possibility of a new hazard, bad data, or insufficient data (i.e., the interpolation scheme uncertainty has significantly increased in that region), etc. all of which could impact worker safety and thus should be accounted for in work planning and optionally displayed on the visual map as stated above.

In some embodiments, the environmental condition mapping server 118 may be able to predict or infer the environmental conditions or exposure levels based on the spatially interpolated measurement data. For example, in cases where workers are carrying location monitoring equipment but no supplemental environmental condition monitoring devices, position measurements for a given worker are used to look up inferred environmental exposure values predicted by the spatially interpolated measurement data. The inferred environmental exposure values may be based on interpolated data which was previously generated by workers/robots that had both environmental condition monitoring devices and position measurement devices. This inference of environmental exposure based on interpolation of pre-existing data could be used as part of normal operation of the industrial facility but would be considered particularly useful following an industrial safety event (e.g., seismic event) given the increased number of workers present in such scenarios, some of whom may only be wearing positional monitors (i.e., without accompanying hazard monitors), given the nature of the work to be performed.

In some embodiments, the environmental exposure data associated with any given worker 102/robot 103, either directly measured from the environmental condition monitoring devices worn by said worker 102/robot 103 or inferred based on the known positional information of said worker 102/robot 103 relative to pre-existing spatially interpolated environmental hazard data, is post-processed (i.e., integrated over time) to calculate the cumulative exposure of the worker 102/robot 103 to the environmental hazard. For example, instantaneous and cumulative environmental exposure levels are estimated for the one or more users utilizing portable positional measurement devices without environmental measurement functionality based on pre-existing spatially interpolated measurement data. In some embodiment, the estimation of instantaneous and cumulative environmental exposure levels is implemented during normal operation of the industrial facility. In other embodiments, the estimation of instantaneous and cumulative environmental exposure levels is implemented following an industrial safety event. Based on calculated level of cumulative exposure, the worker may be notified if their exposure level exceeds a given threshold value.

In some embodiments, the real-time visual map of environmental conditions present in controlled areas of an industrial setting may include a building layout or blueprints documenting the architecture of the industrial setting. The visual map may indicate the magnitude of exposure levels of the environmental factors for particular regions of the industrial setting. It should be appreciated that the visual map may be overlaid onto a 2D floor plan or projected onto the surface of a 3D model of the area (e.g., LIDAR point cloud) for ease of indicating environmental hazards to the workers.

It should be appreciated that the visual maps generated by the environmental condition mapping server 118 may be displayed to workers and other users via the monitoring and positioning device 104, a handheld device such as a mobile phone or tablet device, a central monitoring station, etc. In some embodiments, the monitoring and positioning device 104 may be location-aware and leveraged to alerting the worker to his/her current location to proactively limit the number of entries and/or time spent within in an area with an elevated hazard level based on the results of the calculations performed by the environmental condition mapping server 118. In another embodiment, the environmental condition mapping server 118 may notify the population of workers via their monitoring and positioning device 104 of an industrial safety hazard (e.g., by audible, visual, vibration alarm) when they are inside or near an area that is predicted, based on the spatially interpolated measurement data, to exceed a given threshold value.

With continuing reference to FIG. 1, the analysis software may also include visual and audible cues to alert plant workers to changing environmental conditions, assist in detecting and screening anomalous data, and to help identify individual workers that are approaching their environmental hazard alarm limits so that these workers can be located and instructed to leave the controlled area before limits are exceeded. For example, the software may provide the visual and audible cues to a plant worker's monitoring and positioning device 104 or to work safety personnel to assist them in locating and instructing the worker to leave the controlled area. In another example, the software may provide the visual and audible cues to various locations throughout the plant such as a work safety control station 122, a dashboard display within the controlled area 124, a personal display device 126 at a work location, and the like. The analysis software may also include diagnostics for quantifying changes in environmental conditions associated with specific plant events. In the context of radiation hazards in a nuclear power plant, such events would include but not be limited to draining water from a vessel/component, starting a pump, performing radiography or other maintenance/inspection activities. These diagnostic tools may also be used for post-processing, improved root cause evaluations following elevated worker exposure events, and planning of future work activities similar to those for which data has been acquired (e.g., establish locations with most exposure during a first evolution and develop work plans to avoid these high exposure areas in future similar evolutions).

In other embodiments, the visual maps 120 may be displayed at facility checkpoints to assist work safety personnel in briefing workers prior to work activities. The visual maps 120 may also be displayed on personal devices or in common areas within controlled areas to provide visual aids directly to plant workers during work activities. The software may facilitate display of environmental conditions within a single controlled area or may scroll between multiple controlled areas within the industrial setting. It should be appreciated that because numerous plant workers are contributing data to these visual maps simply by wearing common monitoring devices during their normal work activities, the resolution and confidence level associated with environmental conditions throughout the industrial setting are significantly improved with negligible additional burden on plant staff. In some embodiments, a confidence level may be based on the uncertainties associated with individual environmental and position measurements.

As an exemplary embodiment, FIGS. 1 and 2 show exemplary embodiments of an environmental mapping system 100 which utilizes data from electronic personal dosimeters and positioning devices 104 worn by each individual nuclear facility worker 102 or robot 103. Upon entering a radiologically-controlled area at a nuclear facility (e.g., operating nuclear power plant, nuclear waste facility), each plant worker 102 or robot 103 may wear an electronic personal dosimeter 104 to monitor their radiation exposure during work and non-work activities. It should be appreciated that during work and non-work activities, numerous workers 102 and/or robots 103 may be moving or working within the radiologically-controlled area at any given time. Dose rate data may be obtained using electronic personal dosimeters 104 worn by each plant worker 102 and/or robot 103 and utilized primarily to monitor and document the radiological exposure of the monitored individuals 102/robots 103. While moving or working within the radiological-controlled area, the electronic personal dosimeter 104 for each plant worker 102/robot 103 may obtain dose rate data associated with the plant worker's 102/robot's 103 radiation exposure during work activities.

With reference to FIG. 2, the electronic personal dosimeter 104 may include an electronic dosimeter 106 and position monitoring device 108 that is worn by the plant worker while working in a radiologically-controlled area at a nuclear facility. In another example, the electronic dosimeter 104 may be incorporated into a robot 103 to provide better coverage in areas with dangerous radiation levels. It should be appreciated that such a robot may consist of, but would not be limited to, land-based unmanned vehicles and unmanned drones such as UAVs that are able to reach difficult locations and may be autonomous, semi-autonomous, or remotely operated. It should be appreciated that the electronic personal dosimeter 104 may either be two separate devices (an electronic dosimeter device and position monitoring device) or a single device (a combined electronic dosimeter and position monitoring device) that monitors both dose rate and position data as a function of time.

In some embodiments, the electronic personal dosimeter 104 may monitor different types of radiation, including alpha, beta, gamma, neutron, x-ray or a combination thereof. Personal positioning may be monitored, for example, using radio frequency time-of-flight triangulation techniques using a plurality of positioning beacons placed near or within the radiologically-controlled area and a specialized transceiver worn by the plant worker 102 or integrated into the robot 103.

Once radiation dose rate and position data as a function of time are available on the data collection server, analysis software residing in the environmental condition mapping server 118 may be utilized to analyze and aggregate data from all electronic dosimeters 104 using statistical techniques, and display the data as real-time visual maps 120 of current radiological conditions present in radiologically-controlled areas within the nuclear facility. The magnitude of dose rates, time that has passed since these measurements were obtained, and other factors may be considered in the analysis and display routines to ensure that these visual maps are useful for radiological planning and work activity controls.

The system described herein may accept additional data such as surface or air contamination levels, ambient temperature or other parameters of interest, either manually or using supplemental devices which automatically obtain these data and interface with the environmental mapping system. Similar to environmental factor data described above, these additional data are associated with position and time and can be displayed in equivalent real-time maps or, alternatively/additionally included in the calculations used to generate the desired real-time environmental hazard map for the particular environmental factor of concern as a function of time.

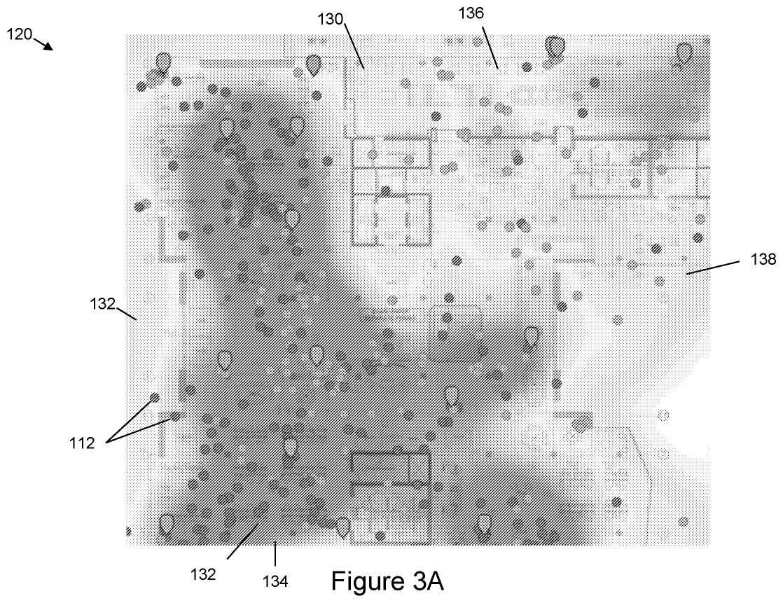

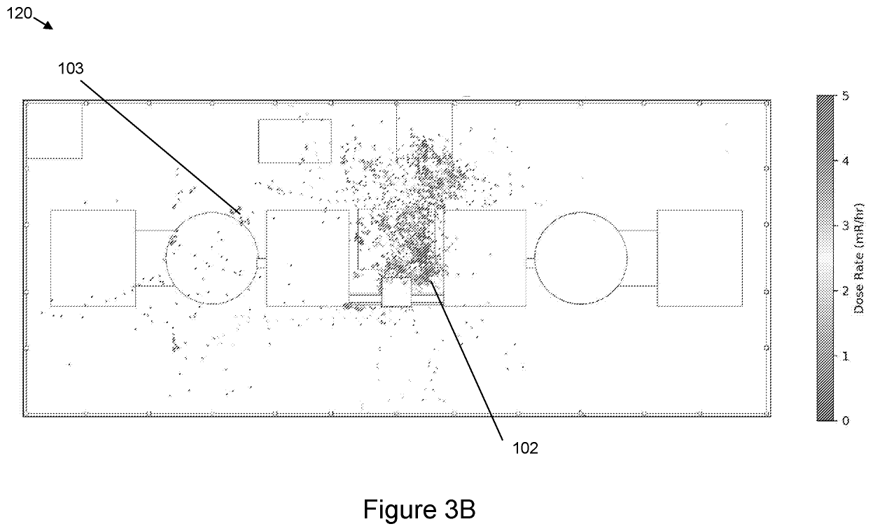

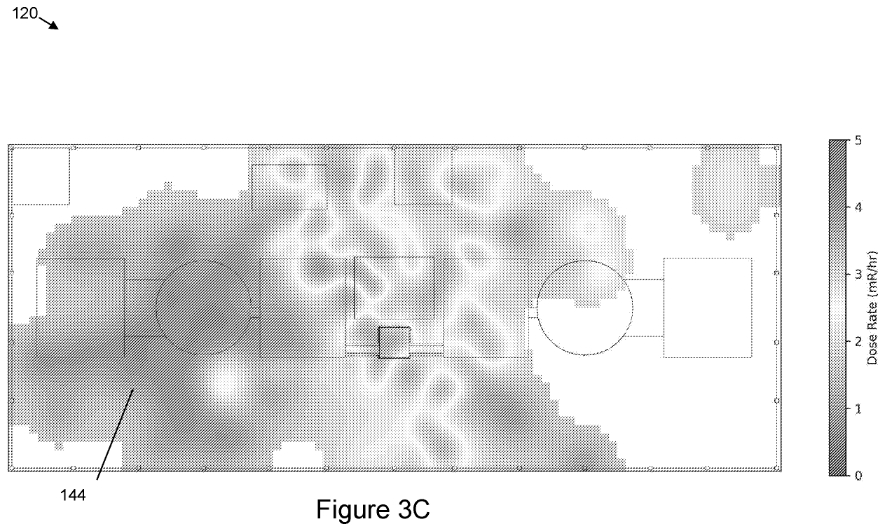

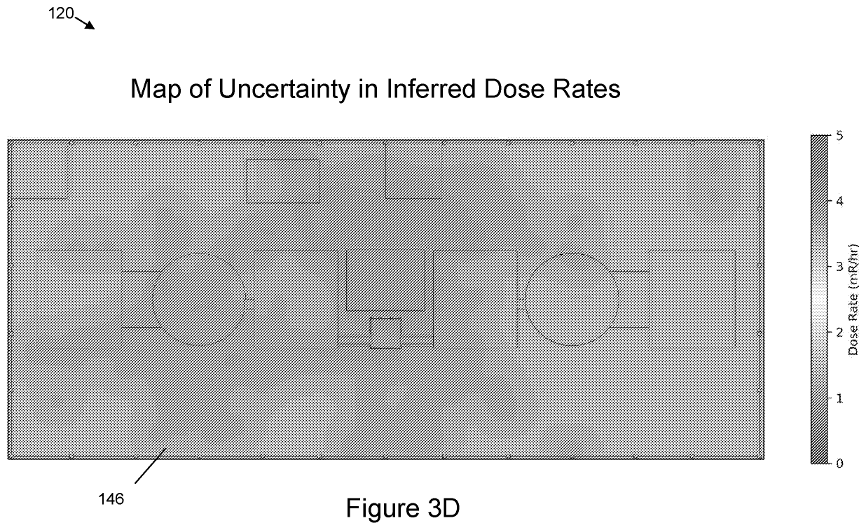

FIGS. 3A-C are exemplary embodiments of a real-time visual map 120 of environmental conditions present in controlled areas within the industrial setting is illustrated. As shown, the visual map 120 may include a building layout or blueprints 130 documenting the architecture of the industrial setting such as a nuclear facility. In some embodiments, the visual map may include color gradients 132, 134, 136, 138 indicating the magnitude of the environmental hazards (e.g. dose rates) in particular regions of the industrial setting. For example, a red region 134 may indicate a high level environmental hazard in a particular region of the industrial setting that may be dangerous for a plant worker to conduct work activities whereas a yellow region 136 or green region 138 may indicate a low level environmental hazards that is safe for work activities. In some embodiments, the location of plant workers 102 may be indicated on the visual map 120.

As an exemplary embodiment, FIG. 3B illustrates an exemplary real-time visual map 120 of radiological conditions present in radiologically-controlled areas within the nuclear facility including a number of dose rate and position data points obtained via devices worn by plant workers 102/robots 103. FIG. 3C illustrates an exemplary real-time visual map 120 of radiological conditions present in radiologically-controlled areas within the nuclear facility including a map of inferred dose rates 144 based on discrete measurements illustrated in FIG. 3B. These dose rate and position data can be continuously obtained and aggregated into visual maps that evolve with time. FIG. 3D illustrates an exemplary real-time visual map 120 of uncertainty in the inferred dose rates 146 at a given time. These uncertainties correspond to the inferred dose rates illustrated in FIG. 3C.

In some embodiments, system 100 shown in FIGS. 1 and 2 provides functionality related to environmental hazard mapping utilizing data from monitoring and positioning devices worn by each individual plant worker/robot via one or more computer systems (i.e. electronic personal dosimeters, servers, etc.) System 100 may comprise a computer system comprising one or more physical processors programmed with one or more computer program instructions and electronic storage, or other components. Various programs and subsystems may be implemented on the physical processors.

In some embodiments, the computer system may include communication lines or ports to enable the exchange of information with a network or other computing platforms. The computer system may include a plurality of hardware, software, and/or firmware components operating together to provide the functionality attributed herein to the computer system. For example, the computer system may be implemented by a cloud of computing platforms operating together as the computer system.

The electronic storage may comprise non-transitory storage media that electronically stores information. The electronic storage media of the electronic storage may include one or both of system storage that is provided integrally (e.g., substantially non-removable) with the computer system or removable storage that is removably connectable to the computer system via, for example, a port (e.g., a USB port, a firewire port, etc.) or a drive (e.g., a disk drive, etc.). The electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a storage area network, and/or other virtual storage resources). The electronic storage may store software algorithms, information determined by the processors, information received from the computer system, information received from client computing platforms, or other information that enables the computer system to function as described herein.

The processors may be programmed to provide information processing capabilities in the computer system. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent processing functionality of a plurality of devices operating in coordination. The processors may be programmed to execute computer program instructions to perform functions described herein. The processors may be programmed to execute computer program instructions by software; hardware; firmware; some combination of software, hardware, or firmware; and/or other mechanisms for configuring processing capabilities on the processors.

Exemplary Flowcharts

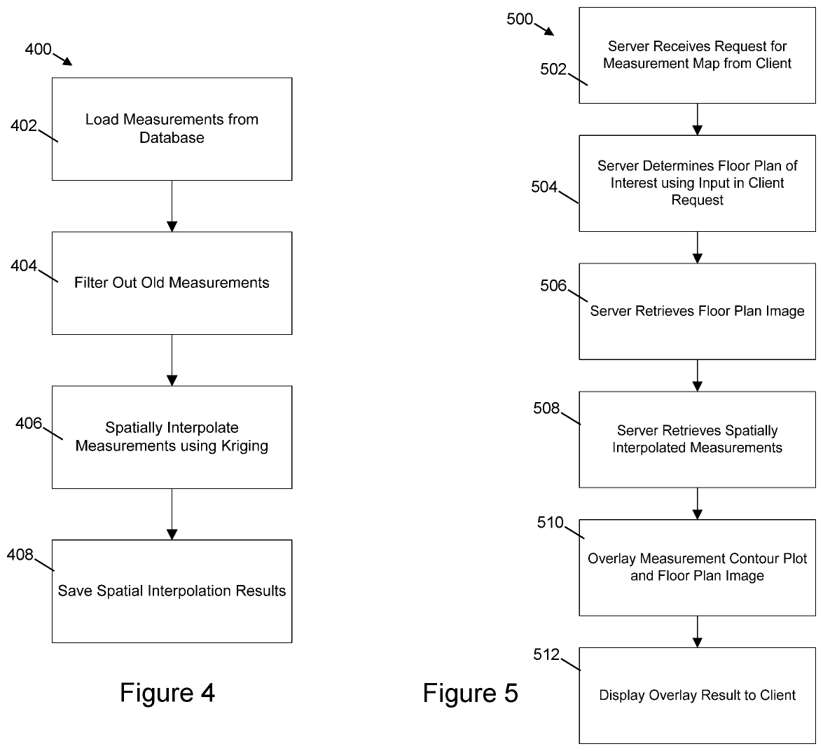

FIG. 4 shows a flowchart of a method 400 for spatial interpolation, in accordance with one or more embodiments. The operations of process 400 presented below are intended to be illustrative. In some implementations, process 400 may be accomplished with one or more additional operations not described, and/or without one or more of the operations discussed. Additionally, the order in which the operations of process 400 are illustrated in FIG. 4 and described below is not intended to be limiting.

In certain implementations, one or more operations of process 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of process 400 in response to instructions stored electronically on an electronic storage medium. The one or more processing devices may include one or more devices configured through hardware, firmware, and/or software to be specifically designed for execution of one or more of the operations of process 400.

In an operation 402, positional measurements are loaded from a database located in the positioning data collection server. For example, the environmental measurement and position data transmitted from the monitoring and positioning devices 104 may be transmitted to and stored in a measurement data collection server 114 and a positioning data collection server 116. In some embodiments, the monitoring and positioning device 104 may utilize the global positioning system (GPS), ultra wideband indoor positioning (UWB), beacon indoor positioning system (BLE), inertial measurement units (IMU), RFID, or other positioning methods to provide the position data.

In an operation 404, prior environmental and positional measurements are filtered out of the measurements dataset. In some embodiments, the prior environmental and positional measurements are saved and utilized to calculate difference between spatially interpolated values from the most recent measurement data and the equivalent spatially interpolated values from the prior measurement data. Based on the results of this calculation, areas having abnormal environmental conditions may be identified.

In an operation 406, the positional measurements are spatially interpolated utilizing a regression model such as a Kriging model. For example, the analysis software may utilize a regression model, such as a Kriging model, that considers uncertainties associated with individual environmental and position measurements and/or variations due to time to create a visual map of environmental conditions that includes inferred predictions for locations with no measurement data.

In an operation 408, the spatial interpolation results are saved. In some embodiments, the spatial interpolation results are transmitted to and utilized by an environmental condition mapping server to display the data as real-time visual maps of current environmental conditions present in controlled areas within the industrial setting

FIG. 5 shows a flowchart of a method 500 for generating and displaying a visual map of environmental conditions present in controlled areas within the industrial setting, in accordance with one or more embodiments. The operations of process 500 presented below are intended to be illustrative. In some implementations, process 500 may be accomplished with one or more additional operations not described, and/or without one or more of the operations discussed. Additionally, the order in which the operations of process 500 are illustrated in FIG. 5 and described below is not intended to be limiting.

In certain implementations, one or more operations of process 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of process 500 in response to instructions stored electronically on an electronic storage medium. The one or more processing devices may include one or more devices configured through hardware, firmware, and/or software to be specifically designed for execution of one or more of the operations of process 500.

In an operation 502, a server receives a request for an environmental condition map from a client. In some embodiments, the environmental condition map is request from the client. In other embodiments, the environmental condition map is requested automatically on a periodic scheduling basis.

In an operation 504, the server determines the floor plan of interest using X, Y, Z input from the client request. For example, the environmental measurement and position data transmitted from the personal/automated monitoring and positioning devices may be transmitted to and stored in a measurement data collection server and a positioning data collection server. In some embodiments, the monitoring and positioning device may utilize the global positioning system (GPS), ultra wideband indoor positioning (UWB), beacon indoor positioning system (BLE), inertial measurement units (IMU), RFID, or other positioning methods to provide the position data. In some embodiment, based on the position data, a corresponding floor plan of interest is determined.

In an operation 506, the server retrieves the floor plan of interest. It should be appreciated that the environmental condition map may be overlaid onto a 2D floor plan or projected onto the surface of a 3D model of the area (e.g., LIDAR point cloud) for ease of indicating environmental hazards to the workers.

In an operation 508, the server retrieves spatially interpolated environmental measurements. For example, the environmental measurement and position data transmitted from the monitoring and positioning devices 104 may be transmitted to and stored in a measurement data collection server 114 and a positioning data collection server 116. Spatially interpolated environmental measurements are then generated from the measurement and position data. In some embodiments, analysis software may utilize a regression model, such as a Kriging model, that considers uncertainties associated with individual environmental and position measurements and/or variations due to time to create a visual map of environmental conditions that includes inferred predictions for locations with no measurement data.

In an operation 510, the environmental measurement contour plot is overlaid on the floor plan image. As previously described, it should be appreciated that the environmental condition map may be overlaid on to a 2D floor plan or projected onto the surface of a 3D model of the area (e.g., LIDAR point cloud) for ease of indicating environmental hazards to the workers.

In an operation 512, the overlaid results are displayed to the client. It should be appreciated that the generated visual maps may be displayed to workers and/or other users via the monitoring and positioning device, a handheld device such as a mobile phone or tablet device, a central monitoring station, etc.

Although the exemplary embodiments have been described in detail for the purpose of illustration based on what are currently considered to be the most practical and preferred embodiments, it is to be understood that such detail is solely for that purpose and that the exemplary embodiments is not limited to the disclosed embodiments, but, on the contrary, is intended to cover modifications and equivalent arrangements that are within the scope of the appended claims. For example, it is to be understood that the exemplary embodiments contemplate that, to the extent possible, one or more features of any embodiment can be combined with one or more features of any other embodiment.

What is claimed is:

1. A method of generating a real-time, crowdsourced visual map summarizing measurements reflecting environmental conditions affecting personnel safety in an industrial facility or work area, the method being implemented by a computer system that includes one or more physical processors executing computer program instructions that, when executed, perform the method, the method comprising:
receiving a request for a measurement map from a user, wherein the request includes an indication of the floor plan of interest of the facility;
retrieving an image of the floor plan of interest;
receiving measurement data and positional data from one or more portable measurement devices, wherein the portable measurement devices are either worn by workers, mounted to robotic platforms, carried by workers as hand-held instruments, or mounted to stationary equipment or structures;
spatially interpolating the received measurement data with the positional data;
overlaying the spatially interpolated measurement data on the floor plan of interest to generate a visual map of environmental conditions affecting personnel safety within the area of interest; and
displaying the visual map to the user.

2. The method of claim 1, wherein the one or more portable measurement devices monitor and transmit measurements related to environmental factors in the industrial facility or work area.

3. The method of claim 2, wherein the monitored environmental conditions include at least one of radiation, chemical species, biological species, airborne particulates, temperature, relative humidity, and noise levels.

4. The method of claim 1, wherein the one or more portable measurement devices provide positional data based on at least one of global positioning system (GPS), ultra wideband indoor positioning (UWB), beacon indoor positioning system (BLE), inertial measurement units (IMU), and RFID.

5. The method of claim 1, wherein the visual map is displayed in a central location such as the work area of interest or worker safety personnel offices.

6. The method of claim 1, wherein the visual map is displayed on one or more portable measurement devices.

7. The method of claim 1, wherein the visual map is overlaid onto 2D (blueprints, floor plans) or 3D (solid model) depictions of the monitored area.

8. The method of claim 1, wherein the industrial facility is a commercial nuclear power plant or nuclear waste facility.

9. The method of claim 1, further including:
post-processing of the measurement data to calculate cumulative exposure of users to one or more environmental hazards; and
notifying individual users via one or more portable measurement devices of their cumulative exposure level approaching or exceeding a pre-determined threshold.

10. The method of claim 9 wherein the cumulative exposure calculation and user notification is performed during normal operation of the industrial facility.

11. The method of claim 9 wherein the cumulative exposure calculation and user notification is performed following the occurrence of an industrial safety event.

12. The method of claim 1, further including:
comparing the spatially interpolated measurement data against one or more predetermined environmental factor thresholds to determine the existence of hazardous environmental conditions; and
identifying one more areas as hazardous if the spatially interpolated measurement data is above or below the one or more predetermined thresholds.

13. The method of claim 12, further including:
determining whether one or more users are located within hazardous areas, as determined based on comparison of the spatially interpolated measurement data and predetermined environmental factor thresholds; and
notifying the user via one or more portable measurement devices of the hazardous conditions.

14. The method of claim 12, further including:
generating visual and/or audible cues in the identified hazardous areas throughout the industrial facility or work area of the hazardous environmental conditions.

15. The method of claim 1, further including:
calculating the difference between most recent spatially interpolated measurement data and previous spatially interpolated measurement data; and
identifying areas as abnormal if the difference exceeds a predetermined threshold.

16. The method of claim 15, further including:
determining whether one or more users are located within the identified abnormal areas; and
notifying the user via one or more portable measurement devices of the abnormal environmental conditions.

17. The method of claim 15, further including:
generating visual and audible cues in the identified abnormal areas throughout industrial facility or work area of the abnormal hazardous environmental conditions.

18. The method of claim 1, further including:
determining whether one or more users are utilizing portable positional measurement devices without environmental measurement functionality; and
estimating instantaneous and cumulative environmental exposure levels for the one or more users utilizing portable positional measurement devices without environmental measurement functionality based on pre-existing spatially interpolated measurement data.

19. The method of claim 18, wherein the estimation of instantaneous and cumulative environmental exposure levels is implemented during normal operation of the industrial facility.

20. The method of claim 18, wherein the estimation of instantaneous and cumulative environmental exposure levels is implemented following an industrial safety event.

21. A system of generating a real-time, crowdsourced visual map summarizing measurements reflecting environmental conditions affecting personnel safety in an industrial facility or work area, the system comprising:
a computer system that includes one or more physical processors programmed with computer program instructions that, when executed, cause the computer system to:
receive a request for a measurement map from a user, wherein the request includes an indication of the floor plan of interest of the facility;
retrieve an image of the floor plan of interest;
receive measurement data and positional data from one or more portable measurement devices in the industrial facility or work area, wherein the portable measurement devices are either worn by workers, mounted to robotic platforms, carried by workers as hand-held instruments, or mounted to stationary equipment or structures;
spatially interpolate the received measurement data with the positional data;
overlay the spatially interpolated measurement data on the floor plan of interest to generate a visual map of industrial safety conditions present within the area of interest; and
display the visual map to the user.

22. The system of claim 21, wherein the one or more portable measurement devices monitor and transmit measurements related to environmental factors in the industrial facility or work area.

23. The system of claim 22, wherein the monitored environmental conditions include at least one of radiation, chemical species, biological species, airborne particulates, temperature, relative humidity, and noise levels.

24. The system of claim 21, wherein the one or more portable measurement devices provide positional data based on at least one of global positioning system (GPS), ultra wideband indoor positioning (UWB), beacon indoor positioning system (BLE), inertial measurement units (IMU), and RFID.

25. The system of claim 21, wherein the visual map is displayed in a central location such as the work area of interest or worker safety personnel offices.

26. The system of claim 21, wherein the visual map is displayed on one or more portable measurement devices.

27. The system of claim 21, wherein the visual map is overlaid onto 2D (blueprints, floor plans) or 3D (solid model) depictions of the monitored area.

28. The system of claim 21, wherein the industrial facility is a commercial nuclear power plant or nuclear waste facility.

29. The system of claim 21, wherein the computer system is further programed to:
post-process the measurement data to calculate cumulative exposure of users to one or more environmental hazards; and
notify individual users via one or more portable measurement devices of their cumulative exposure level approaching or exceeding a pre-determined threshold.

30. The system of claim 29, wherein the cumulative exposure calculation and user notification is performed during normal operation of the industrial facility.

31. The system of claim 29, wherein the cumulative exposure calculation and user notification is performed following the occurrence of an industrial safety event.

32. The system of claim 21, wherein the computer system is further programmed to:
compare the spatially interpolated measurement data against one or more predetermined environmental factor thresholds to determine the existence of hazardous environmental conditions; and
identify one more areas as hazardous if the spatially interpolated measurement data is above or below the one or more predetermined thresholds.

33. The system of claim 32, wherein the computer system is further programmed to:
determine whether one or more users are located within hazardous areas, as determined based on comparison of the spatially interpolated measurement data and predetermined environmental factor thresholds; and
notify the user via one or more portable measurement devices of the hazardous conditions.

34. The system of claim 32, wherein the computer system is further programmed to:
generate visual and/or audible cues in the identified hazardous areas throughout the industrial facility or work area of the hazardous environmental conditions.

35. The system of claim 21, wherein the computer system is further programmed to:
calculate the difference between most recent spatially interpolated measurement data and previous spatially interpolated measurement data; and
identify areas as abnormal if the difference exceeds a predetermined threshold.

36. The system of claim 35, wherein the computer system is further programmed to:
determine whether one or more users are located within the identified abnormal areas; and
notify the user via one or more portable measurement devices of the abnormal environmental conditions.

37. The system of claim 35, wherein the computer system is further programmed to:
generate visual and audible cues in the identified abnormal areas throughout industrial facility or work area of the abnormal environmental conditions.

38. The system of claim 21, wherein the computer system is further programmed to:
determine whether one or more users are utilizing portable positional measurement devices without environmental measurement functionality; and
estimating instantaneous and cumulative environmental exposure levels for the one or more users utilizing portable positional measurement devices without environmental measurement functionality based on pre-existing spatially interpolated measurement data.

39. The system of claim 38, wherein the estimation of instantaneous and cumulative environmental exposure levels is implemented during normal operation of the industrial facility.

40. The system of claim 38, wherein the estimation of instantaneous and cumulative environmental exposure levels is implemented following an industrial safety event.
